(19) United States
(12) Patent Application Publication
(10) Pub. No.: US 2025/0081166 A1
(43) Pub. Date: Mar. 6, 2025

(54) APPARATUS, METHOD, AND COMPUTER PROGRAM

(71) Applicant: Nokia Technologies Oy, Espoo (FI)

(72) Inventors: Nuno Manuel KIILERICH PRATAS, Aalborg (DK); Oana-Elena BARBU, Aalborg (DK); Benny VEJLGAARD, Gistrup (DK); Johannes HARREBEK, Aalborg (DK); Simon SVENDSEN, Aalborg (DK)

(73) Assignee: Nokia Technologies Oy, Espoo (FI)

(21) Appl. No.: 18/818,865

(22) Filed: Aug. 29, 2024

(30) Foreign Application Priority Data
Sep. 1, 2023 (GB) 2313333.3

(51) Int. Cl. H04W 72/04

(52) U.S. Cl. CPC H04W 72/04

(57) ABSTRACT

The disclosure relates to an apparatus configured to: receive (700), from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmit (702), to a device, the activation signal over the first resource.

### FIELD OF THE DISCLOSURE

The present disclosure relates to an apparatus, a method, and a computer program for managing a device (e.g. an Internet of things device) in a communication system.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided an apparatus comprising at least one processor and at least one memory storing instructions that, when executed by the at least one processor, cause the apparatus at least to: receive, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmit, to a device, the activation signal over the first resource.

The network node may be a base station (e.g. gNB) or a user equipment.

The device may be an Internet of things device.

The device may be a passive device and the activation signal may trigger the passive device to transmit a reply signal to a reader user equipment over the second resource.

The reply signal may be dependent on the activation signal. The reply signal may be a backscattered (i.e. reflected) modulation of the activation signal.

The device may be an active device and the activation signal may trigger the active device to transmit a reply signal to a reader user equipment over the second resource.

The reply signal may be independent from the activation signal. The reply signal may not be a backscattered (i.e. reflected) modulation of the activation signal.

The first resource, the second resource and the third resource may comprise a first physical uplink shared channel resource, a second physical uplink shared channel resource and a third physical uplink shared channel resource.

The at least one memory may store instructions that, when executed by the at least one processor, cause the apparatus at least to: receive, from the network node, an indication of a transmission power to transmit the activation signal; and transmit, to the device, the activation signal over the first resource according to the transmission power.

The at least one memory may store instructions that, when executed by the at least one processor, cause the apparatus at least to: receive, from a network node, downlink control information comprising at least one of the indication of the first resource or the indication of the transmission power to transmit the activation signal.

The indication of the transmission power to transmit the activation signal comprises at least one of: the transmission power to transmit the activation signal; or an offset to be applied to an open loop transmission power determined by the apparatus to determine the transmission power to transmit the activation signal.

If the transmission of the activation signal is a first transmission of the activation signal, the offset may be set to a default value; and if the transmission of the activation signal is a subsequent transmission of the activation signal, the offset may be set to a value determined by the network node based on a power control feedback received from a reader user equipment.

The activation signal may comprise an indication of the second resource to transmit a reply signal.

The activation signal may comprise an indication of a transmission power to transmit a reply signal.

The apparatus may comprise an activator user equipment.

According to an aspect there is provided an apparatus comprising means for: receiving, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmitting, to a device, the activation signal over the first resource.

According to an aspect there is provided an apparatus comprising circuitry configured to: receive, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmit, to a device, the activation signal over the first resource.

According to an aspect there is provided a method comprising: receiving, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmitting, to a device, the activation signal over the first resource.

The method may be performed by an apparatus.

The network node may be a base station (e.g. gNB) or a user equipment.

The device may be an Internet of things device.

The device may be a passive device and the activation signal may trigger the passive device to transmit a reply signal to a reader user equipment over the second resource.

The reply signal may be dependent on the activation signal. The reply signal may be a backscattered (i.e. reflected) modulation of the activation signal.

The device may be an active device and the activation signal may trigger the active device to transmit a reply signal to a reader user equipment over the second resource.

The reply signal may be independent from the activation signal. The reply signal may not be a backscattered (i.e. reflected) modulation of the activation signal.

The first resource, the second resource and the third resource may comprise a first 5 physical uplink shared channel resource, a second physical uplink shared channel resource and a third physical uplink shared channel resource.

The method may comprise: receiving, from the network node, an indication of a transmission power to transmit the activation signal; and transmit, to the device, the activation signal over the first resource according to the transmission power.

The method may comprise: receiving, from a network node, downlink control information comprising at least one of the indication of the first resource or the indication of the transmission power to transmit the activation signal.

The indication of the transmission power to transmit the activation signal comprises at least one of: the transmission power to transmit the activation signal; or an offset to be applied to an open loop transmission power determined by the apparatus to determine the transmission power to transmit the activation signal.

If the transmission of the activation signal is a first transmission of the activation signal, the offset may be set to a default value; and if the transmission of the activation signal is a subsequent transmission of the activation signal, the offset may be set to a value determined by the network node based on a power control feedback received from a reader user equipment.

The activation signal may comprise an indication of the second resource to transmit a reply signal.

The activation signal may comprise an indication of a transmission power to transmit a reply signal.

The apparatus may comprise an activator user equipment.

According to an aspect there is provided a computer program comprising computer executable code which when run on at least one processor is configured to: receive, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and transmit, to a device, the activation signal over the first resource.

According to an aspect there is provided an apparatus comprising at least one processor and at least one memory storing instructions that, when executed by the at least one processor, cause the apparatus at least to: receive, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and receive, from a device, the reply signal over the second resource.

The at least one memory may store instructions that, when executed by the at least one processor, cause the apparatus at least to: receive, from the network node, an indication of the first resource to transmit the activation signal; and transmit, to the device, the activation signal over the first resource.

The at least one memory may store instructions that, when executed by the at least one processor, cause the apparatus at least to: receive, from the network node, an indication of the third resource to transmit a report signal; and transmit, to the network node, a report signal.

The at least one memory may store instructions that, when executed by the at least one processor, cause the apparatus at least to: decode a content comprised in the reply signal; and convey the decoded content in the report signal.

The at least one memory may store instructions that, when executed by the at least one processor, cause the apparatus at least to: determine a power control feedback based on the reply signal; and convey the power control feedback in the report signal.

The power control feedback may comprise at least one of: a power measured from the reply signal; a difference between a power measured from the reply signal and a power measured from the activation signal; a signal to interference plus noise ratio measured from the reply signal; or a difference between a signal to interference plus noise ratio measured from the reply signal and a signal to interference plus noise ratio measured from the activation signal.

The apparatus may comprise a reader user equipment.

The apparatus may further comprise an activator user equipment.

According to an aspect there is provided an apparatus comprising means for: receiving, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and receiving, from a device, the reply signal over the second resource.

According to an aspect there is provided an apparatus comprising circuitry configured to: receive, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and receive, from a device, the reply signal over the second resource.

According to an aspect there is provided a method comprising: receiving, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and receiving, from a device, the reply signal over the second resource.

The method may be performed by an apparatus.

The method may comprise: receiving, from the network node, an indication of the first resource to transmit the activation signal; and transmit, to the device, the activation signal over the first resource.

The method may comprise: receiving, from the network node, an indication of the third resource to transmit a report signal; and transmit, to the network node, a report signal.

The method may comprise: decoding a content comprised in the reply signal; and convey the decoded content in the report signal.

The method may comprise: determining a power control feedback based on the reply signal; and convey the power control feedback in the report signal.

The power control feedback may comprise at least one of: a power measured from the reply signal; a difference between a power measured from the reply signal and a power measured from the activation signal; a signal to interference plus noise ratio measured from the reply signal; or a difference between a signal to interference plus noise ratio measured from the reply signal and a signal to interference plus noise ratio measured from the activation signal.

The apparatus may comprise a reader user equipment.

The apparatus may further comprise an activator user equipment.

According to an aspect there is provided a computer program comprising computer executable code which when run on at least one processor is configured to: receive, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and receive, from a device, the reply signal over the second resource.

According to an aspect there is provided an apparatus comprising at least one processor and at least one memory storing instructions that, when executed by the at least one processor, cause the apparatus at least to: transmit, to at least one of an activator user equipment or a reader user equipment, an indication of at least one of a first resource to transmit the activation signal, a second resource to transmit a reply signal or a third resource to transmit a report signal.

The at least one memory may store instructions that, when executed by the at least one processor, cause the apparatus at least to: transmit, to the at least one of the activator user equipment or the reader user equipment, a random access response signal comprising the first indication of at least one of the first resource, the second resource or the third resource; transmit, to the at least one of the activator user equipment or the reader user equipment, a configured grant signal comprising the first indication of at least one of the first resource, the second resource or the third resource; or transmit, to the at least one of the activator user equipment or the reader user equipment, a dynamic grant signal comprising the first indication of at least one of the first resource, the second resource or the third resource.

The at least one memory may store instructions that, when executed by the at least one processor, cause the apparatus at least to: receive, from the activator user equipment, a second indication to allocate the set of resources comprising the first resource, the second resource and the third resource.

The second indication to allocate the set of resources comprising the first resource, the second resource and the third resource may comprise a random access request signal conveying a specific random access channel preamble or a random access request signal transmitted over a specific random access channel resource.

The at least one memory may store instructions that, when executed by the at least one processor, cause the apparatus at least to: transmit, to a plurality of reader user equipment, an indication of the plurality of third resources.

The at least one memory may store instructions that, when executed by the at least one processor, cause the apparatus at least to: transmit, to a lead reader user equipment amongst the plurality of reader user equipment, a random access response signal, a configured grant signal or a dynamic grant signal comprising a fourth indication of a third resource amongst the plurality of third resources; and transmit, to remaining user equipment amongst the plurality of reader user equipment, a grant signal comprising remaining fourth indications of remaining third resources amongst the plurality of third resources.

The apparatus may comprise a network node.

According to an aspect there is provided an apparatus comprising means for: transmitting, to at least one of an activator user equipment or a reader user equipment, an indication of at least one of a first resource to transmit the activation signal, a second resource to transmit a reply signal or a third resource to transmit a report signal.

According to an aspect there is provided an apparatus comprising circuitry configured to: transmit, to at least one of an activator user equipment or a reader user equipment, an indication of at least one of a first resource to transmit the activation signal, a second resource to transmit a reply signal or a third resource to transmit a report signal.

According to an aspect there is provided a method comprising: transmitting, to at least one of an activator user equipment or a reader user equipment, an indication of at least one of a first resource to transmit the activation signal, a second resource to transmit a reply signal or a third resource to transmit a report signal.

The method may be performed by an apparatus.

The method may comprise: transmitting, to the at least one of the activator user equipment or the reader user equipment, a random access response signal comprising the first indication of at least one of the first resource, the second resource or the third resource; transmit, to the at least one of the activator user equipment or the reader user equipment, a configured grant signal comprising the first indication of at least one of the first resource, the second resource or the third resource; or transmit, to the at least one of the activator user equipment or the reader user equipment, a dynamic grant signal comprising the first indication of at least one of the first resource, the second resource or the third resource.

The method may comprise: receiving, from the activator user equipment, a second indication to allocate the set of resources comprising the first resource, the second resource and the third resource.

The second indication to allocate the set of resources comprising the first resource, the second resource and the third resource may comprise a random access request signal conveying a specific random access channel preamble or a random access request signal transmitted over a specific random access channel resource.

The method may comprise: transmitting, to a plurality of reader user equipment, an indication of the plurality of third resources.

The method may comprise: transmitting, to a lead reader user equipment amongst the plurality of reader user equipment, a random access response signal, a configured grant signal or a dynamic grant signal comprising a fourth indication of a third resource amongst the plurality of third resources; and transmit, to remaining user equipment amongst the plurality of reader user equipment, a grant signal comprising remaining fourth indications of remaining third resources amongst the plurality of third resources.

The apparatus may comprise a network node.

According to an aspect there is provided a computer program comprising computer executable code which when run on at least one processor is configured to: transmit, to at least one of an activator user equipment or a reader user equipment, an indication of at least one of a first resource to transmit the activation signal, a second resource to transmit a reply signal or a third resource to transmit a report signal.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AI: Artificial Intelligence
A-IoT: Ambient Internet of Things
AMF: Access and Mobility Management Function
API: Application Programming Interface
BS: Base Station
CU: Centralized Unit
DCI: Downlink Control Information
DL: Downlink
DU: Distributed Unit
gNB: gNodeB
GSM: Global System for Mobile communication
HSS: Home Subscriber Server
IE: Information Element
IoT: Internet of Things
LMF: Location Management Function
LPP: Location Positioning Protocol
LTE: Long Term Evolution
MAC: Medium Access Control
ML: Machine Learning
MS: Mobile Station
MTC: Machine Type Communication
NEF: Network Exposure Function
NF: Network Function
NR: New radio
NRF: Network Repository Function
PDU: Packet Data Unit
PUSCH: Physical Uplink Shared Channel
PRACH: Physical Random Access Channel
RACH: Random Access Channel
RAM: Random Access Memory
(R) AN: (Radio) Access Network
ROM: Read Only Memory
SINR: Signal to Interference plus Noise Ratio
SMF: Session Management Function
TR: Technical Report
TS: Technical Specification
UE: User Equipment
UMTS: Universal Mobile Telecommunication System
3GPP: 3rd Generation Partnership Project
5G: 5th Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a user equipment;

FIG. 4 (a) shows a schematic representation of a first topology comprising a controlling node and a transmitting node;

FIG. 4 (b) shows a schematic representation of a second topology comprising an activator user equipment, an ambient Internet of things device and a reader user equipment;

FIG. 5 shows a signalling diagram of a process for managing a device (e.g. an Internet of things device) in a communication system;

FIG. 6 shows a signalling diagram of a process for managing a device (e.g. an Internet of things device) in a communication system, wherein physical uplink shared resources allocated by a base station are transmitted to a reader user equipment in a random access response signal and to an activator user equipment in a dynamic grant signal;

FIG. 7 shows a block diagram of a method for managing a device (e.g. an Internet of things device) in a communication system performed by an apparatus, such as an activator user equipment;

FIG. 8 shows a block diagram of a method for managing a device (e.g. an Internet of things device) in a communication system performed by an apparatus, such as an reader user equipment;

FIG. 9 shows a block diagram of a method for managing a device (e.g. an Internet of things device) in a communication system performed by an apparatus, such as an base station; and

FIG. 10 shows a schematic representation of a non-volatile memory medium storing instructions which when executed by a processor allow a processor to perform one or more of the steps of the methods of FIG. 7 to FIG. 9.

### DETAILED DESCRIPTION OF THE FIGURES

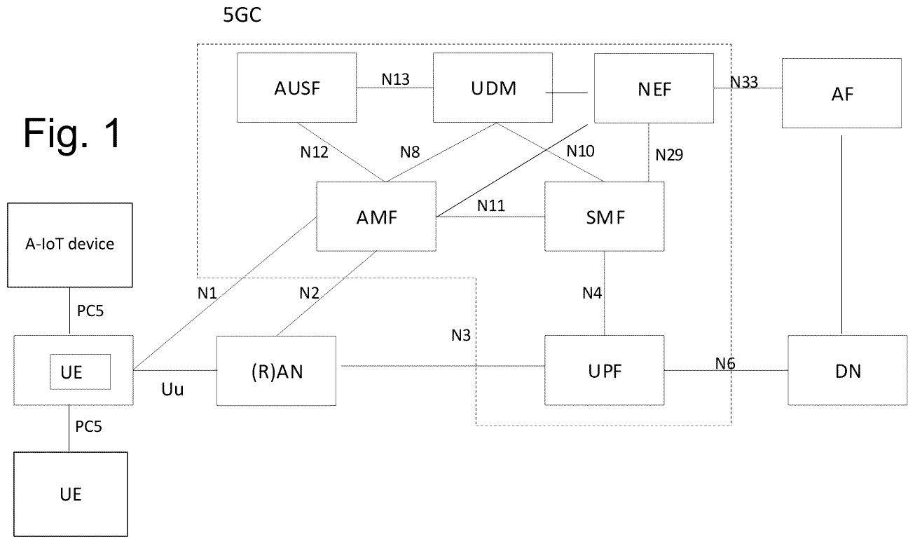

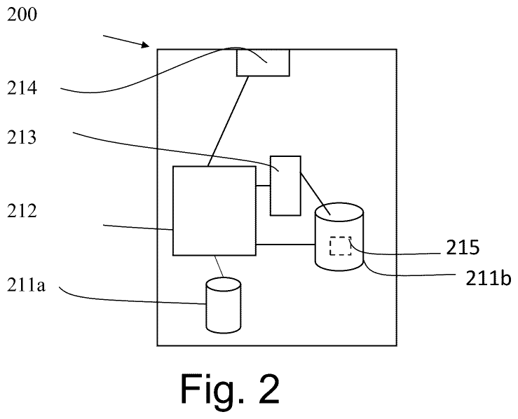

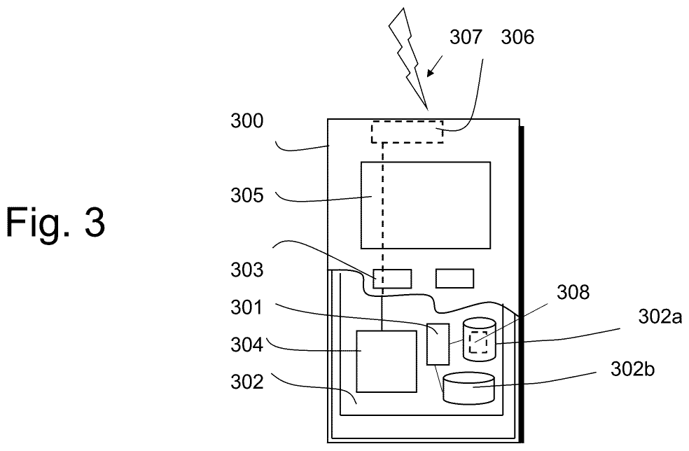

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1, FIG. 2 and FIG. 3 to assist in understanding the technology underlying the described examples.

FIG. 1 shows a schematic representation of a 5G system (5GS). The 5GS may comprises Internet of things (IoT) devices, user equipment (UEs), a (radio) access network ((R) AN), a 5G core network (5GC), one or more application functions (AF) and one or more data networks (DN).

The IoT devices may comprise ambient IoT (A-IoT) devices. An A-IoT device may be configured to measure ambient conditions, such as location, temperature, pressure, noise, light or other ambient conditions. An A-IoT device may comprise a sensor.

The UE may comprise activator UEs, reader UEs or activator and reader UEs. An activator UE may be configured to transmit an activation signal to an A-IoT device to trigger the A-IoT device to transmit a reply signal to a reader UE. A reader UE may be configured to receive a reply signal from an A-IoT device and to transmit a report signal to the 5G (R) AN.

The A-IoT device may be of different types.

AIoT device type A may refer to AIoT device that does not have energy storage and that is not capable of transmitting a reply signal to a reader UE independent from an activation signal received from an activator UE. The A-IoT may comprise a passive radio frequency transmission component. The A-IoT device may be capable of transmitting a reply signal dependent from an activation signal received from an activator UE. The reply signal may be a backscattered (i.e. reflected) modulation of the activation signal received from an activator UE. The modulation may be used to convey content, such as an identifier of the A-IoT device or a measurement performed by the A-IoT device. The power of the activation signal received from the activator UE may be controlled by the activator UE.

An AIoT device type B may refer to AIoT device that has energy storage and that is not capable of transmitting a reply signal to a reader UE independent from an activation signal received from an activator UE. The A-IoT may comprise a passive radio frequency transmission component. The A-IoT device may be capable of transmitting a reply signal dependent from an activation signal received from an activator UE. The reply signal may be a backscattered (i.e. reflected) modulation of the activation signal received from an activator UE., such as an identifier of the A-IoT device or a measurement performed by the A-IoT device. The power of the activation signal received from the activator UE may be controlled by the activator UE. The power of the reply signal transmitted by the A-IoT device may be controlled by the A-IoT device.

An AIoT device type C may refer to an AIoT device that has energy storage and that is capable of transmitting a reply signal independent from an activation signal received from an activator UE. The A-IoT may comprise an active radio frequency transmission component. The power of the activation signal received from the activator UE may be controlled by the activator UE. The power of the reply signal transmitted by the A-IoT device may be controlled by the A-IoT device.

The 5G (R) AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF), a network exposure function (NEF), a unified data repository (UDR), an application function (AF) and/or a location management function (LMF).

FIG. 2 illustrates an example of a control apparatus 200 for controlling a function of the (R) AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R) AN or the 5GC. In some embodiments, each function of the (R) AN or the 5GC comprises a control apparatus 200. In alternative embodiments, two or more functions of the (R) AN or the 5GC may share a control apparatus.

FIG. 3 illustrates an example of a user equipment 300, such as the terminal illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

In a communication system, the transmission power of a signal transmitted by a transmission node to a controlling node may be controlled in an open loop or in a closed loop.

In an open loop, the transmission node may measure the power of a signal transmitted by the controlling node to the transmission node and may set the transmission power of a signal transmitted by the transmission node to the controlling node based on the measurement.

In a closed loop, the controlling node may receive a signal transmitted by the transmission node to the controlling node. The controlling node may measure the power of the signal transmitted by the transmission node to the controlling node and may determine a transmission power command (TPC) based on the measurement. The transmission node may receive the TPC from the controlling node and may set the transmission power of a subsequent signal transmitted by the transmission node to the controlling node based on the TPC.

For cellular communications over a Uu interface, the controlling node may be a BS and the transmission node may be a UE. For sidelink communications over a PC5 interface, the controlling node may be a UE and the transmission node may be another UE.

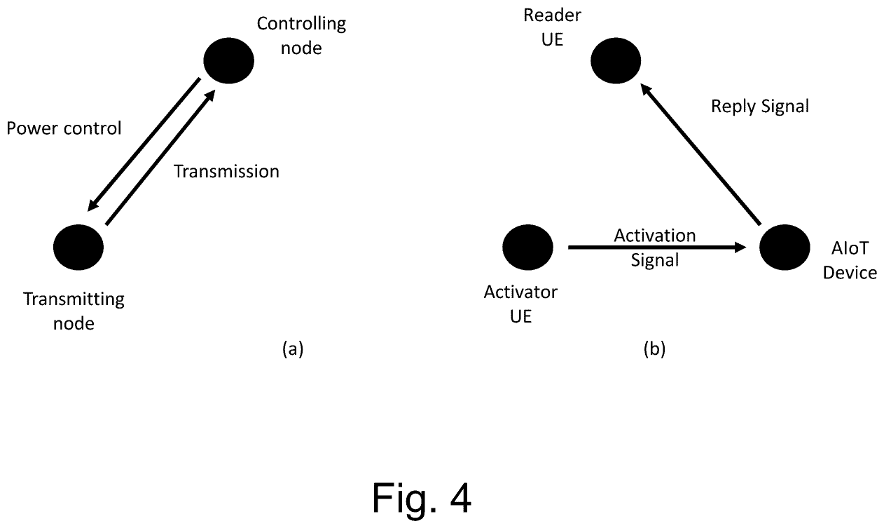

FIG. 4 (a) shows a schematic representation of a first topology comprising a controlling node and a transmitting node.

FIG. 4 (b) shows a schematic representation of a second topology comprising an activator UE, an A-IoT device and a reader UE. The activator UE and the reader UE may be different UEs or may be a same UE.

One or more aspects of this disclosure relates to managing an A-IoT device in a communication system.

Managing an A-IoT device may comprise at least one of allocating a first resource to transmit an activation signal from an activator UE to the A-IoT device, allocating a second resource to transmit a reply signal from the A-IoT device to a reader UE, allocating a third resource to transmit a report signal from the reader UE to a gNB.

The first resource to transmit an activation signal from an activator UE to the A-IoT device and the second resource to transmit a reply signal from the A-IoT device to a reader UE may be the same in time and/or frequency when the type of the A-IoT device is A-IoT device type A or A-IoT device type B.

Managing an A-IoT device may comprise at least one of controlling the power of the activation signal transmitted from an activator UE to the A-IoT device or controlling the power of the reply signal transmitted from the A-IoT device to a reader UE.

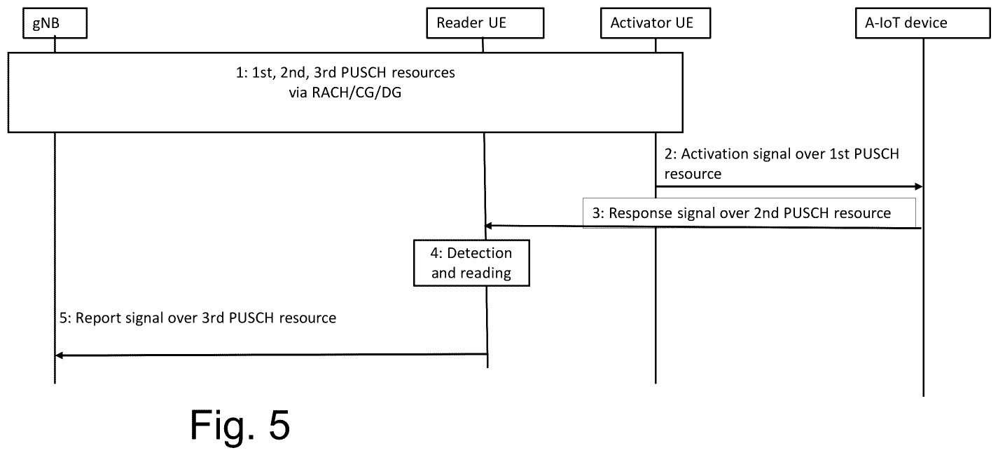

FIG. 5 shows a signalling diagram of a process for managing an A-IoT device. The process involves a gNB, an activator UE, a reader UE and the A-IoT.

Here, the activator UE and the reader UE are different UEs but it will be understood that the activator UE and the reader UE may be a same UE.

Here a single reader UE is involved but it will be understood that multiple reader UEs may be used.

Here, a gNB is involved but it will be understood that the gNB may be replaced by another user equipment.

At a step 1, the gNB may allocate a set of PUSCH resources (i.e. times and/or frequencies) comprising a first PUSCH resource, a second PUSCH resource and a third PUSCH resource.

The gNB may transmit, to the activator UE, at least one of a random access response signal, a configured grant signal or a dynamic grant signal. The random access response signal, configured grant signal or dynamic grant signal may comprise downlink control information (DCI).

The DCI may comprise an indication of the first PUSCH resource to transmit an activation signal from the activator UE to the A-IoT device and the second PUSCH resource to transmit the reply signal from the A-IoT device to the reader UE. The indication may explicit or implicit.

The DCI may comprise an indication of a transmission power to transmit the activation signal from the activator UE to the A-IoT device. The indication may explicit or implicit. The indication may comprise a TPC. The TPC may comprise the transmission power to transmit the activation signal from the activator UE to the A-IoT device or information to determine the transmission power to transmit the activation signal to the A-IoT device. Information to determine the transmission power to transmit the activation signal to the A-IoT device may comprise an offset to be applied to an open loop transmission power determined by the activator UE. The open loop transmission power may be determined by the activator UE based on a measurement of a power of a signal transmitted by the gNB to the activator UE or based on a measurement of a power of a signal transmitted by the reader UE to the activator UE. If the transmission of the activation signal by the activator UE to the A-IoT device is a first transmission of the activation signal, the offset may be set to a default value. If the transmission of the activation signal by the activator UE to the A-IoT device is a subsequent transmission of the activation signal, the offset may be set to a value determined by the gNB. The value may be determined by the gNB based on a power control feedback received from the reader UE.

The DCI may comprise an indication of a transmission power to transmit the reply signal from the A-IoT device to the reader UE. The indication may comprise a TPC. The TPC may comprise the transmission power to transmit the reply signal from the A-IoT device to the reader UE or information to determine the transmission power to transmit the reply signal from the A-IoT device to the reader UE. Information to determine the transmission power to transmit the reply signal from the A-IoT device to the reader UE may comprise an offset to be applied to an open loop transmission power determined by the A-IoT device. The open loop transmission power may be determined by the A-IoT device based on a measurement of a power of a signal transmitted by the gNB to the A-IoT device, based on a measurement of a power of a signal transmitted by the activator UE to the IoT device or based on a measurement of a power of a signal transmitted by the reader UE to the A-IoT device. If the transmission of the reply signal by the the A-IoT device to the reader UE is a first transmission of the reply signal, the offset may be set to a default value. If the transmission of the reply signal by the A-IoT device to the reader UE is a subsequent transmission of the reply signal, the offset may be set to a value determined by the gNB. The value may be determined by the gNB based on the power control feedback received from the reader UE.

A new DCI format may be defined with new fields providing the indication of the first PUSCH resource to transmit the activation signal from the activator UE to the A-IoT device and the second PUSCH resource to transmit the reply signal from the A-IoT device to the reader UE, the indication of the transmission power to transmit the activation signal from the activator UE to the A-IoT device and the indication of the transmission power to transmit the reply signal from the A-IoT device to the reader UE in addition to existing fields defined in 3GPP TS 38.212 table 7.3.1-1).

The gNB may transmit, to the reader UE, a random access response signal, a configured grant signal or a dynamic grant signal. The random access response signal, configured grant signal or dynamic grant signal may comprise DCI.

The DCI may comprise an indication of the first PUSCH resource to transmit the activation signal from the activator UE to the A-IoT device, the second PUSCH resource to transmit the reply signal from the A-IoT device to the reader UE and the third PUSCH resource to transmit the report signal from the reader UE to the gNB.

A new DCI format may be defined to comprise a fields providing the indication of the first PUSCH resource to transmit the activation signal from the activator UE to the A-IoT device, the second PUSCH resource to transmit the reply signal from the A-IoT device to the reader UE and the third PUSCH resource to transmit the report signal from the reader UE to the gNB in addition to existing fields defined in 3GPP TS 38.212 table 7.3.1-1.

At a step 2, the activator UE may receive the random access response signal, configured grant signal or dynamic grant signal. The activator UE may decode a content of the random access response signal, configured grant signal or dynamic grant signal. The activator UE may transmit, to the A-IoT device, an activation signal over the first PUSCH resource. The activator UE may transmit an activation signal over the first PUSCH resource to the A-IoT device according to the transmission power to transmit the activation signal.

The activation signal may comprise an indication of the second PUSCH resource to transmit the reply signal from the A-IoT device to the reader UE. The indication may explicit or implicit.

The activation signal may comprise an indication of a transmission power to transmit the reply signal from the A-IoT device to the reader UE (e.g. when the type of the A-IoT device is A-IoT device type C). The indication may explicit or implicit.

The activation signal may comprise an indication to generate the reply signal by the A-IoT device. The indication may explicit or implicit. For example, the activation signal may comprise a sequence that triggers the AIoT device to generate the reply message (explicit indication). Alternatively, the reception of the activation signal implies that the AIoT device needs to generate the reply message (implicit indication).

The reader UE may receive the activation signal from the activator UE over the first PUSCH resource. The reader UE may measure a power of the activation signal.

The A-IoT device may receive the activation signal from the activator UE over the first PUSCH resource. It may be assumed that the A-IoT device is configured to receive the activation signal at any time. The A-IoT device may decode a content of the activation signal. The A-IoT device may transmit the reply signal to the reader UE over the second PUSCH resource.

At a step 3, the reader UE may receive the reply signal from the A-IoT device over the second PUSCH resource.

The reader UE may decode a content of the reply signal. The content of the reply signal may comprise an identifier of the A-IoT device. The content of the reply signal may comprise a measurement performed by the A-IoT device. The reader UE may convey the decoded content of the reply signal in a report signal.

The reader UE may determine a power control feedback based on the reply signal (e.g. when the reader UE fails to decode the content of the reply signal). The reader UE may convey the power control feedback in the report signal.

In an example, the reader UE may measure a power of the reply signal and may convey the power of the reply signal in the report signal.

In another example, the reader UE may measure a difference between a power of the reply signal and a power of the activation signal may convey the difference between the power of the reply signal and the power of the activation signal in the report signal.

In another example, the reader UE may measure a signal to interference plus noise ratio of the reply signal and may convey the signal to interference plus noise ratio of the reply signal in the report signal.

In another example, the reader UE may measure a difference between a signal to interference plus noise ratio of the reply signal and a signal to interference plus noise ratio of the activation signal and may convey the difference between the signal to interference plus noise ratio of the reply signal and the signal to interference plus noise ratio of the activation signal in the report signal.

At a step 4, the reader UE may transmit, to the gNB, the report signal.

The gNB may receive the report signal. The gNB may decode the content of the report signal. The gNB may use the content of the report signal, for example to detect, read or localize the A-IoT device.

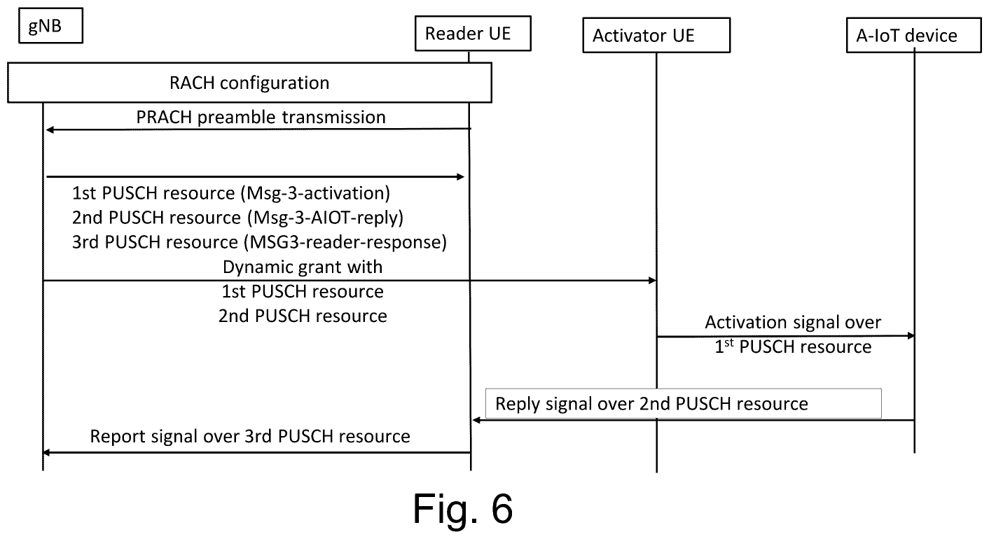

FIG. 6 shows a signalling diagram of a process for managing an A-IoT device. The process involves a gNB, an activator UE, a reader UE and the A-IoT.

Here, the activator UE and the reader UE are different UEs but it will be understood that the activator UE and the reader UE may be a same UE.

Here, a single reader UE is involved but it will also be understood that multiple reader UEs may be used.

Here, a gNB is involved but it will be understood that the gNB may be replaced by another user equipment.

The gNB may transmit, to a reader UE, a RACH configuration signal.

The RACH configuration signal may convey a specific PRACH preamble or a specific PRACH resource to be used by the reader UE to implicitly indicate to the gNB to allocate a set of PUSCH resources comprising a first PUSCH resource, a second PUSCH resource and a third PUSCH resource. The set of PUSCH resources may depend on a type of an A-IoT device (e.g. A-IoT device type A, IoT device type B or IoT device type C) to be activated.

The RACH configuration signal may convey a specific PRACH preamble or a specific PRACH resource to be used by the reader UE to implicitly indicate to the gNB a type of an A-IoT device (e.g. A-IoT device type A, IoT device type B or IoT device type C) to be activated.

The reading UE may receive the RACH configuration signal. The reading UE may decode the RACH configuration signal. The reading UE may select the specific PRACH preamble. The reading UE may select the specific PRACH resource.

The reader UE may transmit, to the gNB, a random access request signal conveying the specific PRACH preamble. The reading UE may transmit, to the gNB, a random access request signal over the specific PRACH resource.

The gNB may receive the random access request signal. The gNB may decode the random access request signal.

The gNB may allocate a set of PUSCH resources comprising a first PUSCH resource, a second PUSCH resource and a third PUSCH resource based on the specific PRACH preamble. The gNB may allocate a set of PUSCH resources comprising a first PUSCH resource, a second PUSCH resource and a third PUSCH resource based on the specific PRACH resource.

The gNB may transmit, to the reader UE, a random access response signal. The random access response may comprise DCI. The DCI may comprise an indication of the first PUSCH resource to transmit the activation signal from the activator UE to the A-IoT device, the second PUSCH resource to transmit the reply signal from the A-IoT device to the reader UE and the third PUSCH resource to transmit the report signal from the reader UE to the gNB (e.g. Msg3-activation, Msg3-AIoT-reply, Msg3-reader-report). The indication may explicit or implicit.

The reader UE may receive the random access response signal. The reader UE may decode the random access response signal.

The gNB may transmit, to the activator UE, at least one dynamic grant signal. The at least one dynamic grant signal may comprise DCI. The DCI may comprise an indication of the first PUSCH resource to transmit the activation signal from the activator UE to the A-IoT device and the second PUSCH resource to transmit the reply signal from the A-IoT device to the reader UE. The indication may explicit or implicit.

The activator UE may receive the at least one dynamic grant signal. The activator UE may decode the at least one dynamic grant signal.

The activator UE may transmit the activation signal to the A-IoT device over the first PUSCH resource.

The reader UE may receive the activation signal from the activator UE over the first PUSCH resource. The reader UE may measure a power of the activation signal.

The A-IoT device may receive the activation signal from the activator UE over the first PUSCH resource. The A-IoT device may decode the activation signal from the activator UE.

The A-IoT device may transmit the reply signal to the reader UE over the second PUSCH resource.

The reader UE may receive the reply signal from the A-IoT device over the second PUSCH resource.

The reader UE may decode a content of the reply signal. The reader UE may convey the decoded content of the reply signal in a report signal.

The reader UE may determine a power control feedback based on the reply signal (e.g. when the reader UE fails to decode the content of the reply signal). The reader UE may convey the power control feedback in the report signal.

The reader UE may transmit, to the gNB, the report signal over the third PUSCH resource.

The gNB may receive the report signal. The gNB may decode the content of the report signal. The gNB may use the content of the report signal, for example to detect, read or localize the A-IoT device.

In some implementation, the reader UE and the activator UE may be a same UE. The gNB may transmit, to the UE, a single configured grant signal comprising the indication of the first PUSCH resource to transmit the activation signal from the activator UE to the

A-IoT device, the second PUSCH resource to transmit the reply signal from the A-Iot device to the reader UE and the third PUSCH to transmit the report signal from the reader UE to the gNB. The UE may receive the configured grant signal whilst being in a radio resource control connected state or whilst transitioning to a radio resource control inactive state.

Alternatively, the gNB may transmit, to the UE, a first dynamic grant signal comprising the indication of the first PUSCH resource to transmit the activation signal from the activator UE to the A-IoT device, a second dynamic grant signal comprising the indication of the second PUSCH resource to transmit the reply signal from the A-Iot device to the reader UE and a third dynamic grant signal comprising an indication of the third PUSCH to transmit the report signal from the reader UE to the gNB. The UE may receive the first dynamic grant signal, the second dynamic grant signal and the third dynamic grant signal whilst being in a radio resource control connected state.

In some implementation, a plurality of reader UEs may be used instead of a single reader UE The plurality of reader UEs may comprise a lead reader UE that initiates the process and remaining reader UEs.

The gNB may allocate the first PUSCH resource to transmit the activation signal from the activator UE to the A-IoT device, the second PUSCH resource to transmit the reply signal from the A-Iot device to the reader UE and a plurality of third PUSCH resources to transmit the report signal from the reader UE to the gNB.

The gNB may transmit, to the lead reader UE, at least one of a random access response, a configured grant signal or a dynamic grant signal comprising the indication of the first PUSCH resource to transmit the activation signal from the activator UE to the A-IoT device, the second PUSCH resource to transmit the reply signal from the A-IoT device to the reader UE and a third PUSCH resource amongst the plurality of third PUSCH resources to transmit the report signal from the reader UE to the gNB.

The gNB may transmit, to the remaining reader UEs, at least one dynamic grant signal comprising the indication of the first PUSCH resource to transmit the activation signal from the activator UE to the A-IoT device, the second PUSCH resource to transmit the reply signal from the A-IoT device to the reader UE and a third PUSCH resource amongst the plurality of third PUSCH resources to transmit the report signal from the reader UE to the gNB.

The gNB may transmit, to the activator UE, at least one dynamic grant signal comprising the indication of the first PUSCH resource to transmit the activation signal from the activator UE to the A-IoT device and the second PUSCH resource to transmit the reply signal from the A-IoT device to the reader UE.

Each reader UE amongst the plurality of reader UEs may receive the reply signal from the A-IoT device over the second PUSCH resource. Each reader UE amongst the plurality of reader UEs may decode a content of the reply signal. Each reader UE amongst the plurality of reader UEs may convey the decoded content of the reply signal in a report signal. Each reader UE amongst the plurality of reader UEs may determine a power control feedback based on the reply signal (e.g. when the reader UE fails to decode the content of the reply signal). Each reader UE amongst the plurality of reader UEs may convey the power control feedback in the report signal. Each reader UE amongst the plurality of reader UEs may transmit, to the gNB, the report signal over a third PUSCH resource amongst the plurality of third PUSCH resources.

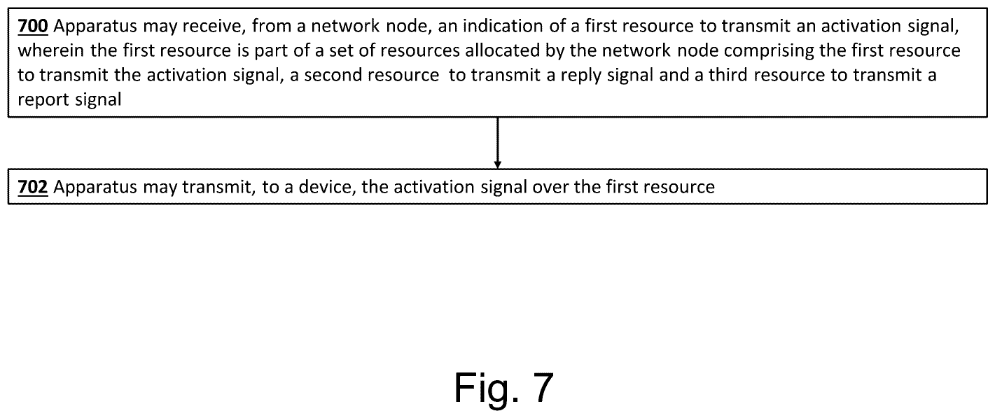

FIG. 7 shows a block diagram of a method for managing an A-IoT device in a communication system performed by an apparatus, such as an activator UE.

In step 700, the apparatus may receive, from a network node, an indication of a first resource to transmit an activation signal, wherein the first resource is part of a set of resources allocated by the network node comprising the first resource to transmit the activation signal, a second resource to transmit a reply signal and a third resource to transmit a report signal.

In step 702, the apparatus may transmit, to a device, the activation signal over the first resource.

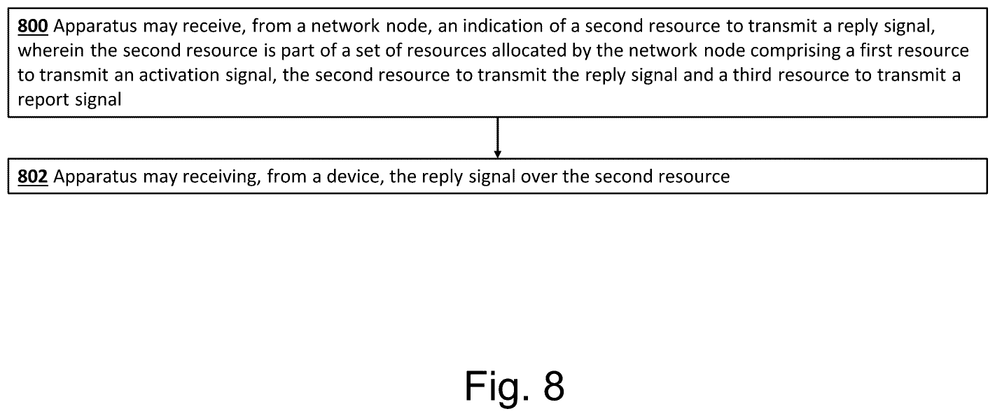

FIG. 8 shows a block diagram of a method for managing an A-IoT device in a communication system performed by an apparatus, such as an reader UE.

In step 800, the apparatus may receive, from a network node, an indication of a second resource to transmit a reply signal, wherein the second resource is part of a set of resources allocated by the network node comprising a first resource to transmit an activation signal, the second resource to transmit the reply signal and a third resource to transmit a report signal.

In step 802, the apparatus may receive, from a device, the reply signal over the second resource.

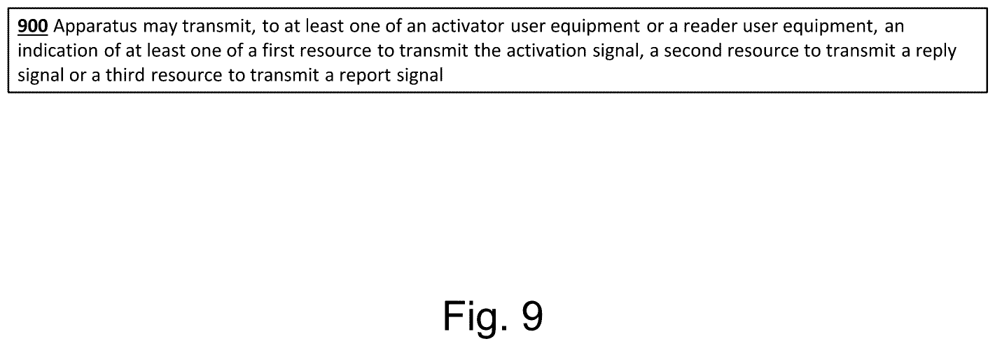

FIG. 9 shows a block diagram of a method for managing an A-IoT device in a communication system performed by an apparatus, such as an BS or a UE.

In step 900, the apparatus may transmit, to at least one of an activator user equipment or a reader user equipment, an indication of at least one of a first resource to transmit the activation signal, a second resource to transmit a reply signal or a third resource to transmit a report signal.

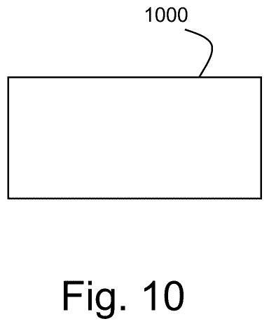

FIG. 10 shows a schematic representation of non-volatile memory media 1000 storing instructions which when executed by a processor allow the processor to perform one or more of the steps of the methods of FIG. 7 to FIG. 9.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 7 to FIG. 9, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising at least one processor and at least one memory storing instructions that, when executed by the at least one processor, cause the apparatus at least to:
receive, from a network node, an indication of a first resource to transmit an activation signal, wherein the first resource is part of a set of resources allocated by the network node comprising the first resource to transmit the activation signal, a second resource to transmit a reply signal and a third resource to transmit a report signal; and
transmit, to a device, the activation signal over the first resource.

2. The apparatus of claim 1, wherein the at least one memory stores instructions that, when executed by the at least one processor, cause the apparatus at least to:
receive, from the network node, an indication of a transmission power to transmit the activation signal; and
transmit, to the device, the activation signal over the first resource according to the transmission power.

3. The apparatus of claim 2, wherein the at least one memory stores instructions that, when executed by the at least one processor, cause the apparatus at least to:
receive, from a network node, downlink control information comprising at least one of the indication of the first resource or the indication of the transmission power to transmit the activation signal.

4. The apparatus of claim 2, wherein the indication of the transmission power to transmit the activation signal comprises at least one of:
the transmission power to transmit the activation signal; or
an offset to be applied to an open loop transmission power determined by the apparatus to determine the transmission power to transmit the activation signal.

5. The apparatus of claim 4, wherein if the transmission of the activation signal is a first transmission of the activation signal, the offset is set to a default value; and
wherein if the transmission of the activation signal is a subsequent transmission of the activation signal, the offset is set to a value determined by the network node based on a power control feedback received from a reader user equipment.

6. The apparatus of claim 1, wherein the activation signal comprises an indication of the second resource to transmit a reply signal.

7. The apparatus of claim 1, wherein the activation signal comprises an indication of a transmission power to transmit a reply signal.

8. The apparatus of claim 1, wherein the apparatus comprises an activator user equipment.

9. An apparatus comprising at least one processor and at least one memory storing instructions that, when executed by the at least one processor, cause the apparatus at least to:
receive, from a network node, an indication of a second resource to transmit a reply signal, wherein the second resource is part of a set of resources allocated by the network node comprising a first resource to transmit an activation signal, the second resource to transmit the reply signal and a third resource to transmit a report signal; and
receive, from a device, the reply signal over the second resource.

10. The apparatus of claim 9, wherein the at least one memory stores instructions that, when executed by the at least one processor, cause the apparatus at least to:
receive, from the network node, an indication of the first resource to transmit the activation signal; and
transmit, to the device, the activation signal over the first resource.

11. The apparatus of claim 9, wherein the at least one memory stores instructions that, when executed by the at least one processor, cause the apparatus at least to:
receive, from the network node, an indication of the third resource to transmit a report signal; and
transmit, to the network node, a report signal.

12. The apparatus of claim 9, wherein the at least one memory stores instructions that, when executed by the at least one processor, cause the apparatus at least to:
decode a content comprised in the reply signal; and
convey the decoded content in the report signal.

13. The apparatus of claim 9, wherein the at least one memory stores instructions that, when executed by the at least one processor, cause the apparatus at least to:
determine a power control feedback based on the reply signal; and
convey the power control feedback in the report signal.

14. The apparatus of claim 13, wherein the power control feedback comprises at least one of:
a power measured from the reply signal;
a difference between a power measured from the reply signal and a power measured from the activation signal;
a signal to interference plus noise ratio measured from the reply signal; or
a difference between a signal to interference plus noise ratio measured from the reply signal and a signal to interference plus noise ratio measured from the activation signal.

15-16. (canceled)

17. An apparatus comprising at least one processor and at least one memory storing instructions that, when executed by the at least one processor, cause the apparatus at least to:
transmit, to at least one of an activator user equipment or a reader user equipment, an indication of at least one of a first resource to transmit the activation signal, a second resource to transmit a reply signal or a third resource to transmit a report signal.

18. The apparatus of claim 17, wherein the at least one memory stores instructions that, when executed by the at least one processor, cause the apparatus at least to:
transmit, to the at least one of the activator user equipment or the reader user equipment, a random access response signal comprising the first indication of at least one of the first resource, the second resource or the third resource;
transmit, to the at least one of the activator user equipment or the reader user equipment, a configured grant signal comprising the first indication of at least one of the first resource, the second resource or the third resource; or
transmit, to the at least one of the activator user equipment or the reader user equipment, a dynamic grant signal comprising the first indication of at least one of the first resource, the second resource or the third resource.

19. The apparatus of claim 17, wherein the at least one memory stores instructions that, when executed by the at least one processor, cause the apparatus at least to:
receive, from the activator user equipment, a second indication to allocate the set of resources comprising the first resource, the second resource and the third resource.

20. The apparatus of claim 19, wherein the second indication to allocate the set of resources comprising the first resource, the second resource and the third resource comprises a random access request signal conveying a specific random access channel preamble or a random access request signal transmitted over a specific random access channel resource.

21. The apparatus of claim 19, wherein the at least one memory stores instructions that, when executed by the at least one processor, cause the apparatus at least to:
transmit, to a plurality of reader user equipment, an indication of the plurality of third resources.

22. The apparatus of claim 21, wherein the at least one memory stores instructions that, when executed by the at least one processor, cause the apparatus at least to:
transmit, to a lead reader user equipment amongst the plurality of reader user equipment, a random access response signal, a configured grant signal or a dynamic grant signal comprising a fourth indication of a third resource amongst the plurality of third resources; and
transmit, to remaining user equipment amongst the plurality of reader user equipment, a grant signal comprising remaining fourth indications of remaining third resources amongst the plurality of third resources.

23-27. (canceled)
